(19) United States
(12) Patent Application Publication
(10) Pub. No.: US 2019/0213592 A1
(43) Pub. Date: Jul. 11, 2019

(54) FRACTIONAL FUND TRANSFER AND ACCUMULATION SYSTEM, PROGRAM, AND METHOD

(71) Applicant: Nomura Research Institute, Ltd., Tokyo (JP)

(72) Inventors: Tatsuo TANAKA, Tokyo (JP); Yoshinobu HIGUCHI, Tokyo (JP)

(73) Assignee: Nomura Research Institute, Ltd., Tokyo (JP)

(21) Appl. No.: 15/573,019

(22) PCT Filed: May 25, 2017
(86) PCT No.: PCT/JP2017/019614

§ 371 Date: Nov. 9, 2017

(30) Foreign Application Priority Data
May 27, 2016 (JP) 2016-106202

(51) Int. Cl. G06Q 20/40; G06Q 20/10; G06Q 40/06

(52) U.S. Cl. CPC G06Q 20/405; G06Q 40/06; G06Q 20/10

(57) ABSTRACT

A predetermined fractional amount of money is calculated on the basis of daily expenditures or the like of a user, and transferred as money saved for a target amount of money. To this end, there are provided a fund calculation rules DB11 which stores predetermined fund calculation rules information, an account information DB12 which receives and stores account information regarding a fund account of a customer from a financial institution apparatus 30, fund calculation means 13 which calculates a transfer amount of money of a transfer fund to be transferred to a predetermined accumulation account from the fund account of the customer on the basis of the fund calculation rules information and the account information, a fund calculation result DB14 which stores fund calculation result information, fund transfer instruction means 15 which transmits fund transfer instruction information to the financial institution apparatus 30 on the basis of the fund calculation result information, a fund transfer result DB16 which receives and stores the fund calculation result information from the financial institution apparatus 30, and accumulated fund reference means 17 which transmits predetermined accumulated fund information to a customer terminal 40. The fund calculation means 13 calculates, as the transfer amount of money, a fractional amount of money indicated by a difference between an amount of money charged to the fund account of the customer and a predetermined set amount of money.

### TECHNICAL FIELD

The present invention relates to an art of supporting, for example, investments to and operations of financial products. More particularly, it relates to a fractional fund transfer and accumulation system which is effective for customers to save funds to purchase financial products, and a program and a method for use in the system.

### BACKGROUND ART

In general, financial institutions such as banks and securities companies provide their customers (users) such as personal investors with various financial products to effectively conduct investments, asset management, and the like.

Here, in order to effectively form assets by financial products, it is desirable to purchase a financial product costing a certain amount of money. In addition, minimum purchase prices or minimum deposit amounts are often set for some financial products.

Thus, in order to conduct effective investments, asset management, and the like by financial products, there is first a need for a fund to purchase a desired financial product. Therefore, for the user, effective formation and saving of a fund to purchase the desired financial product is an important issue.

It is common to restrain and hold down daily expenditures, and at the same time, for example, save a certain amount of money every month to form the fund to purchase the financial product by saving.

However, although restraining and holding down daily expenditures are desirable, vaguely restraining expenditures is actually difficult unless there is a specific numerical target or the like, and it has been difficult to achieve the saving of a target amount of money merely by “reducing and holding down expenditures”.

On the other hand, to save a certain amount of money every month, for example, installment savings or the like can be used so that money is reserved by automatic drawing, whereby a target amount of money can be certainly saved.

However, if a certain amount of money is forcibly saved every month, reserving money itself can be hard in some cases depending on the user's income and expenditure status or the like at the time, for example, when urgent expenditures increase. Therefore, it often happens that saving of a target amount of money ends in failure, including a cancellation before maturity.

Furthermore, saving in which a certain amount of money is automatically deducted is conducted independently of the user's efforts, behavioral patterns, or the like to restrain expenditures, and is uninteresting, and has hardly motivated or prompted the user to save money.

Accordingly, there have been demands for techniques and services which awaken the user's consciousness of voluntary saving and expenditure restraint so that the user actively saves money and which effectively save a target amount of money in a flexible and mobile form that is not a mere fixed reserve or the like. Nevertheless, no effective suggestions have been made so far.

In addition, PATENT LITERATURE 1 discloses an “automatic saving system” which automatically saves a part of a refund when the refund is given from an account of a financial institution.

According to this system in PATENT LITERATURE 1, “more deposit refunds increase deposits”, and a deposit balance in an account for automatic saving can be improved accordingly.

### CITATION LIST

### Patent Literatures

[PATENT LITERATURE 1] Japanese Patent Appln. KOKAI Publication No. 2003-132224

### SUMMARY OF INVENTION

### Technical Problem

However, according to the system disclosed in PATENT LITERATURE 1, a part of the refund amount of the deposit (e.g. 20% of the refund amount) is saved in and moved to another account for saving, and the increase of the saving amount increases the refund amount as much.

Thus, for example, if an extra refund is given in anticipation of an amount (20% of the refund amount) taken for saving, the total amount of saving of the user is not increased, which can not be said to be an effective saving method.

Furthermore, only taking a part of the refund amount for saving does not encourage expenditure restraint and hold-down, and does not provide, for example, any target or interest of saving either, but rather leads to concerns of useless and unnecessary refunds because “more deposit refunds increase deposits”.

Therefore, this system in PATENT LITERATURE 1 can not solve the issue of restraining and holding down daily expenditures and keeping up saving for the fund to purchase the aforementioned financial products.

The present invention has been suggested to solve the issues of the conventional arts described above, and is intended to provide a fractional fund transfer and accumulation system, and a program and a method for use in the same which are suitable for, for example, saving of funds to purchase a financial product, wherein a predetermined fractional amount of money is calculated on the basis of daily expenditures or the like of a user, and transferred as money saved for a target amount of money, whereby continuous saving can be efficiently achieved to a reasonable extent, and expenditure restraint, hold-down, and the like are also encouraged so that a positive action for saving can be naturally promoted and induced.

### Solution to Problem

To achieve the above object, a fractional fund transfer and accumulation system according to the present invention transfers a fund to a predetermined accumulation account from a fund account of a customer on the basis of rule information set in response to an input operation by the customer, and thereby accumulates a predetermined target amount of money. The fractional fund transfer and accumulation system includes fund calculation rules storage means which stores predetermined fund calculation rules information set in response to an input operation, account information storage means which stores account information regarding the fund account of the customer, fund calculation means which calculates a transfer amount of money of a transfer fund to be transferred to the predetermined accumulation account from the fund account of the customer on the basis of the fund calculation rules information, fund transfer instruction means which transmits predetermined fund transfer instruction information to a predetermined financial institution apparatus that manages the fund account of the customer on the basis of the calculated transfer amount of money, and accumulated fund information generating means which generates predetermined accumulated fund information including the transfer amount of money. The following rules are settable as the fund calculation rules: a fractional rule to calculate, as the transfer amount of money, a fractional amount of money indicated by a difference between an amount of money in predetermined usage details information or transaction information and a predetermined set amount of money, a periodic rule to calculate, as the transfer amount of money, a predetermined fixed amount of money in every predetermined period set by a user, and an additional rule to calculate, as the transfer amount of money, a predetermined amount of money set by the user when event information preset by the user is input.

Furthermore, the present invention is configurable as a fractional fund transfer and accumulation program which is executed in the fractional fund transfer and accumulation system according to the present invention described above.

Yet further, the present invention is also configurable as a fractional fund transfer and accumulation method which can be implemented by the fractional fund transfer and accumulation system and program according to the present invention described above.

### Advantageous Effects of the Invention

According to the present invention, a predetermined fractional amount of money can be calculated on the basis of daily expenditures or the like of a user, and transferred as money saved for a target amount of money.

Consequently, continuous saving can be efficiently achieved to a reasonable extent, and expenditure restraint, hold-down, and the like are also encouraged so that a positive action for saving can be naturally promoted and induced.

It is therefore possible to provide services which flexibly meet diverse needs of investors and which are suitable to cause personal investors in particular to save a fund to purchase a financial product.

### BRIEF DESCRIPTION OF DRAWINGS

FIG. 1 is a block diagram showing the configuration of a fractional fund transfer and accumulation system according to one embodiment of the present invention;

FIG. 2 is an explanatory view showing one example of “fund calculation rules” which are settable in the fractional fund transfer and accumulation system according to one embodiment of the present invention;

FIG. 3 is an explanatory view showing one example of a processing operation of fund transfer in the fractional fund transfer and accumulation system according to one embodiment of the present invention;

FIG. 4 is an explanatory view following FIG. 3, showing one example of the processing operation of fund transfer in the fractional fund transfer and accumulation system according to one embodiment of the present invention;

FIG. 5 is an explanatory view showing one example of display screens output and displayed at a customer terminal in the fractional fund transfer and accumulation system according to one embodiment of the present invention, wherein (a) shows accumulated fund information at a point corresponding to FIG. 3, and (b) shows accumulated fund information at a point corresponding to FIG. 4;

FIG. 6 is an explanatory view showing one example of display screens output and displayed at the customer terminal in the fractional fund transfer and accumulation system according to one embodiment of the present invention, wherein (a) shows a setting screen which selectably displays various setting items settable in the fractional fund transfer and accumulation system, (b) shows a setting screen of the “fund calculation rules” which is set in (a), and (c) shows a setting screen of a “monthly closing date” which is also set in (a);

FIG. 7 is an explanatory view showing one example of display screens output and displayed at the customer terminal in the fractional fund transfer and accumulation system according to one embodiment of the present invention, wherein (a) shows a setting screen of an “alert announcement” which is selected in FIG. 6(a), (b) shows a setting screen of a “monthly target amount of money to be saved” and a “saving rule” for the alert announcement which are selected in (a), and (c) shows a setting screen of the “monthly target amount of money to be saved” which is set in FIG. 6(a);

FIG. 8 is an explanatory view showing one example of display screens output and displayed at the customer terminal in the fractional fund transfer and accumulation system according to one embodiment of the present invention, wherein (a) shows a setting screen of an “account for fund saving” which is selected in FIG. 6(a), (b) shows a setting screen of “create a new account for fund saving” which is selected in (a), and (c) shows a setting screen of an account for “fund-raising” which is selected and set in (b);

FIG. 9 is an explanatory view showing one example of the processing operation of fund transfer in the fractional fund transfer and accumulation system according to one embodiment of the present invention, and shows a case where the account for “fund-raising” is set in addition to a “normal” account in a fund status corresponding to FIG. 3;

FIG. 10 is an explanatory view showing one example of display screens output and displayed at the customer terminal in the fractional fund transfer and accumulation system according to one embodiment of the present invention, wherein (a) shows accumulated fund information for the “normal” account at a point corresponding to FIG. 9, and (b) similarly shows accumulated fund information for the account for “fund-raising”;

FIG. 11 is an explanatory view following FIG. 9, showing one example of the processing operation of fund transfer in the fractional fund transfer and accumulation system according to one embodiment of the present invention, and shows a case where a fund is transferred to the account for “fund-raising” in a fund status corresponding to FIG. 4;

FIG. 12 is an explanatory view showing one example of display screens output and displayed at the customer terminal in the fractional fund transfer and accumulation system according to one embodiment of the present invention, wherein (a) shows accumulated fund information for the “normal” account at a point corresponding to FIG. 11, and (b) similarly shows accumulated fund information for the account for “fund-raising”;

FIG. 13 is an explanatory view showing one example of display screens output and displayed at the customer terminal in the fractional fund transfer and accumulation system according to one embodiment of the present invention, wherein (a) shows a setting screen of “create a new account for fund saving” similar to that in FIG. 8(b), (b) shows a setting screen of the account for “fund-raising” which is selected and set in (a), and (c) shows a details setting screen of “common” which is selected in (b); and

FIG. 14 is a diagram showing a hardware configuration of a server or a terminal in the fractional fund transfer and accumulation system according to one embodiment of the present invention.

### DESCRIPTION OF EMBODIMENTS

Hereinafter, an embodiment of a fractional fund transfer and accumulation system according to the present invention will be described with reference to the drawings.

Here, the fractional fund transfer and accumulation system of the present invention shown below is obtained by processes, means, and functions which are executed by a computer under instructions from a program (software). The program can send instructions to each component of the computer, and cause the computer to perform predetermined processes and functions according to the present invention shown below. That is, each of the processes, means, and functions in the present invention are obtained by specific means in which the program and the computer cooperate with each other.

In addition, the program is entirely or partly provided by, for example, a magnetic disk, an optical disk, a semiconductor memory, and any other computer-readable recording media, and the program read from the recording medium is installed in the computer and then executed. The program can be also directly loaded onto the computer through a communication line without the intervention of any recording medium, and then executed. Further, the fractional fund transfer and accumulation system according to the present invention can be configured by a single information processing apparatus (e.g. a single personal computer), and can be also configured by more than one information processing apparatus (e.g. more than one server computer).

[System Configuration]

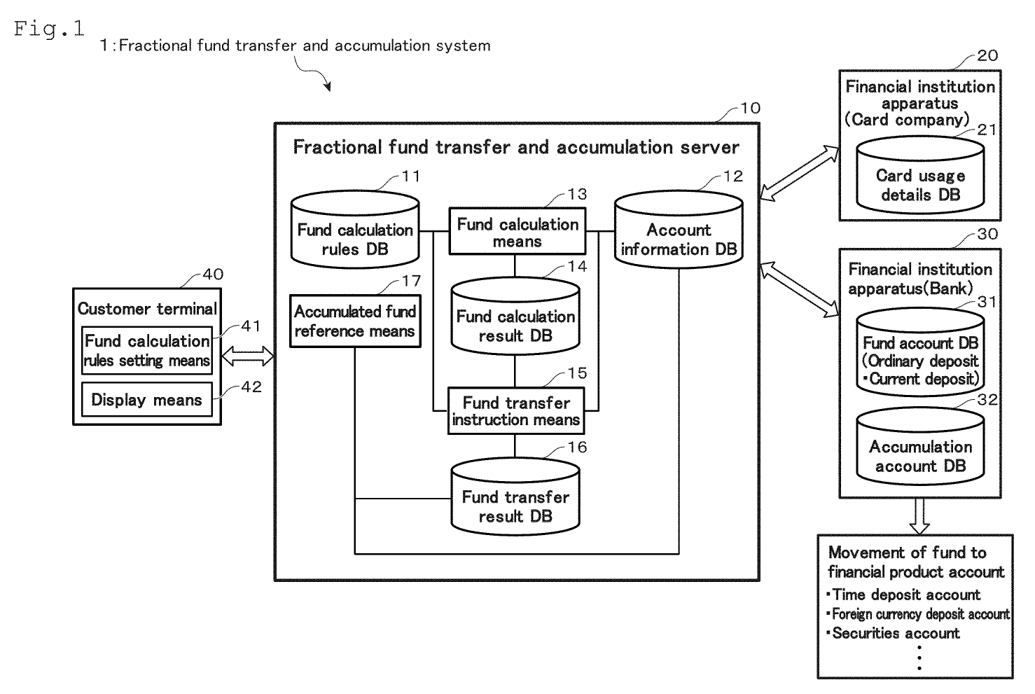

FIG. 1 shows the configuration of the fractional fund transfer and accumulation system according to one embodiment of the present invention.

The system according to one embodiment of the present invention shown in FIG. 1 is configured as a fractional fund transfer and accumulation system 1 which comprises a fractional fund transfer and accumulation server 10, financial institution apparatuses 20 and 30, and a customer terminal 40.

The fractional fund transfer and accumulation server 10, the financial institution apparatuses 20 and 30, and the customer terminal 40 that constitute the fractional fund transfer and accumulation system 1 are connected via a predetermined network such as the Internet to permit mutual data communication.

[Fractional Fund Transfer and Accumulation Server 10]

The fractional fund transfer and accumulation server 10 is an information processing apparatus which transfers a fund to a predetermined accumulation account from a fund account of a customer on the basis of rule information set in response to an input operation by the customer, and thereby accumulates a predetermined target amount of money, and the fractional fund transfer and accumulation server 10 constitutes the fractional fund transfer and accumulation system according to the present invention.

Specifically, the fractional fund transfer and accumulation server 10 can be configured, for example, by one or two or more server computers, or a server system comprising one or two or more virtual servers constructed on a cloud computing service. In addition, the components of the fractional fund transfer and accumulation server 10 shown in FIG. 1 can also be suitably provided in the customer terminal 40; for example, a fund calculation rules DB11, fund calculation means 13, and a fund calculation result DB14 can be mounted on the customer terminal 40.

This fractional fund transfer and accumulation server 10 comprises an operating system (OS), a database management system (DBMS), and others that are not shown, and is operated as a server computer.

Further, a software which operates on a middleware such as a Web server program is mountable on the fractional fund transfer and accumulation server 10.

This software discloses and provides applications available to one or two or more customer terminals 40 via a network such as the Internet in the form of, for example, an application programming interface (API).

Thus, each of the customer terminals 40 can execute the functions of the fractional fund transfer and accumulation system according to the present invention by invoking an exclusive application program, Web browser, and others which are provided to customers (hereinafter referred to as “users”) of financial institutions and which are operated to provide services such as proposals or advice for asset management.

Furthermore, the fractional fund transfer and accumulation server 10 comprises the fund calculation rules DB11, an account information DB12, and a fund transfer result DB16 which are mounted as databases or the like and which will be described later, and also comprises storage means which acquires and storages predetermined information necessary to operate the fractional fund transfer and accumulation system according to the present invention.

The storage means stores, as various information resources, the user's account information, attribute information, and transaction history information in financial institutions which will be described later, and also stores predetermined information necessary for the fractional fund transfer and accumulation server 10 according to the present embodiment. Necessary information is read according to need along with the operation of the fractional fund transfer and accumulation server 10, and then stored and updated.

In addition, the information which is stored and accumulated in the fractional fund transfer and accumulation server 10 as above can be periodically extracted, for example, by daily processing from an independent financial institution system serving as a counting-oriented and information-oriented information processing system owned by each of the financial institutions comprising the financial institution apparatuses 20 and 30, or from a financial institution mission-critical system which provides a counting-oriented and information-oriented information processing system to more than one financial institution, and then acquired and stored in the fractional fund transfer and accumulation server 10. When there is no independent information processing system or external mission-critical system with which the financial institutions can collaborate, various kinds of information can be, for example, manually registered and stored in the fractional fund transfer and accumulation server 10.

Furthermore, the information stored in the fractional fund transfer and accumulation server 10 can be acquired and referred to in other programs (e.g. an application or the like of the customer terminal 40) via a network. Moreover, when the information stored in the fractional fund transfer and accumulation server 10 can be acquired and referred to in the program of the financial institution apparatus 20 or 30 via a network, the financial institution (a card company or a bank) can analyze the user's lifestyle and preference from the rules and the transaction history information set by the user, and use the analysis for marketing.

Then, specifically, as shown in FIG. 1, the above fractional fund transfer and accumulation server 10 is configured to function as the fund calculation rules DB11, the account information DB12, the fund calculation means 13, the fund calculation result DB14, fund transfer instruction means 15, the fund transfer result DB16, and accumulated fund reference means 17.

The fund calculation rules DB11 is means which stores predetermined fund calculation rules information including a target amount of money set in response to an input operation from the customer terminal 40 that will be described later.

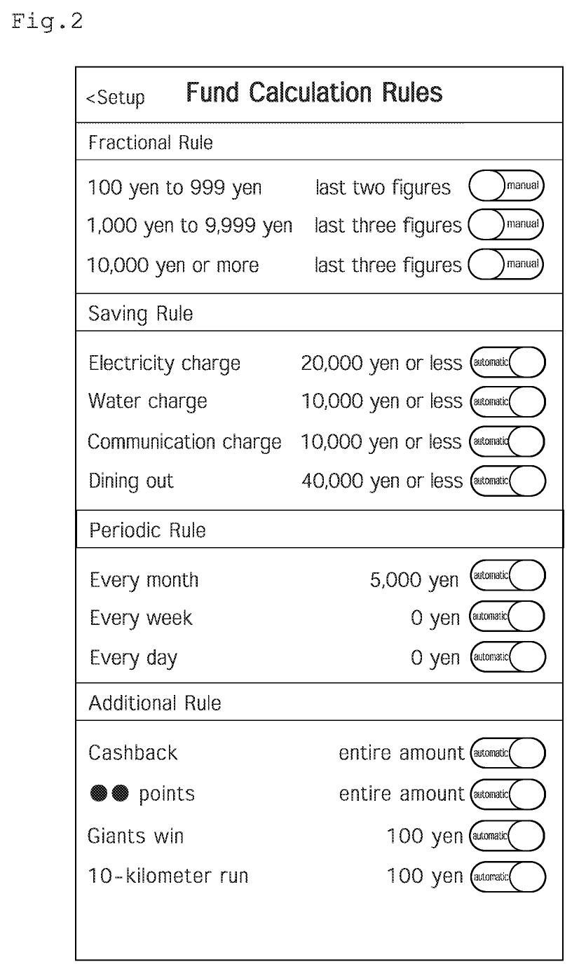

Here, the fund calculation rules information which is stored in the fund calculation rules DB11 includes, for example, a predetermined target amount of money, and various rules (a fraction rule, a saving rule, a periodic rule, and an additional rule) to achieve the target amount of money, as predetermined information set by the user via the customer terminal 40, as will be described later (see FIG. 2 which will be described later).

The account information DB12 is storage means which receives and stores account information regarding the fund account or the like of the customer from the financial institution apparatuses 20 and 30 which manage fund accounts or the like of the users.

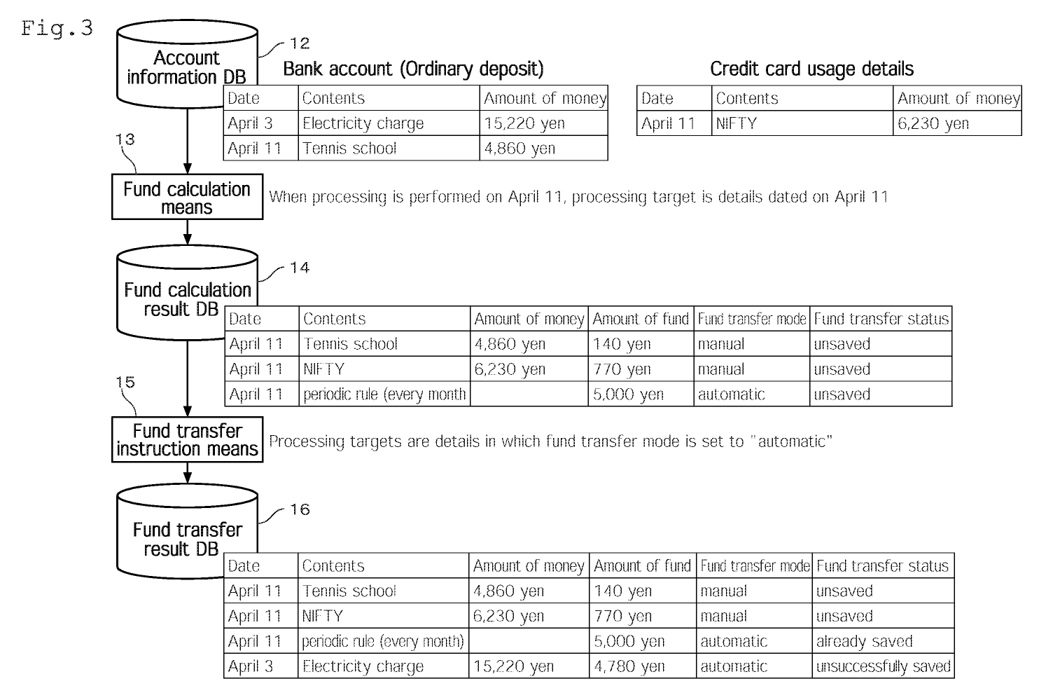

Here, the account information which is stored in the account information DB12 includes, for example, usage details information of cards transmitted from the financial institution apparatus 20 of the card company that will be described later, and transaction information for the fund account transmitted from the financial institution apparatus 30 of the bank (see FIGS. 3, 4, 9, and 11 which will be described later).

The fund calculation means 13 is means which calculates a transfer fund (a transfer amount of money) to be transferred to a predetermined accumulation account from the fund account of the customer, on the basis of the aforementioned fund calculation rules information and account information (see FIGS. 3, 4, 9, and 11 which will be described later).

Specifically, the fund calculation means 13 calculates a fractional amount of money indicated by a difference between an amount of money charged to the fund account of the user and a predetermined set amount of money, as the transfer amount of money according to the present invention.

Moreover, the fund calculation means 13 can calculate a predetermined fixed amount of money together with or instead of the fractional amount of money, as the “transfer amount of money” according to the present invention.

In addition, the fund calculation means 13 can calculate the aforementioned fixed amount of money as the “transfer amount of money” when predetermined event information is input.

Furthermore, the fund calculation means 13 can calculate that the aforementioned amount of money charged to the fund account of the user has reached a predetermined value, and cause the later-described accumulated fund reference means 17 to transmit, to the customer terminal 40, information such as an alert announcement indicating that the amount of money charged has reached the predetermined value.

The fund calculation means 13 can also calculate, when a target amount of money for a predetermined period (e.g. one month) is set, a possibility that the total transfer amount of money within this predetermined period may not reach the target amount of money, and cause the accumulated fund reference means 17 to transmit, to the customer terminal 40, information (e.g. an alert announcement) indicating the possibility that the total transfer amount of money may not reach the target amount of money. The possibility that the transfer amount of money may not reach the target amount of money can be estimated by the comparison with past (e.g. previous-month) achievements.

Such notification as the alert announcement is given so that, for example, when the later-described saving rule can not be kept because of the increase in the amount of money charged or when there is a possibility that achieving the target amount of money may be difficult, the user can be informed of this fact and encouraged to stop wasting and save money.

The fund calculation result DB14 is storage means which stores information indicating a fund calculation result including the transfer fund calculated in the fund calculation means 13.

The fund calculation result information which is stored in the fund calculation result DB14 is predetermined information that includes the aforementioned “transfer amount of money” computed and calculated in the fund calculation means 13 and that is necessary to perform later-described transfer processing to the accumulation account from the fund account (see FIGS. 3, 4, 9, and 11 which will be described later).

The fund transfer instruction means 15 is means which transmits predetermined fund transfer instruction information to the financial institution apparatus 30 on the basis of the fund calculation result information stored in the fund calculation result DB14.

The fund transfer result DB16 is means which receives and stores, from the financial institution apparatus 30 which has transmitted the fund transfer instruction information, information indicating a fund transfer result based on the fund transfer instruction information.

The fund transfer result information which is stored in the fund transfer result DB16 is predetermined information indicating the result of the aforementioned transfer processing to the accumulation account from the fund account executed in the financial institution apparatus 30 under the aforementioned instruction of the fund transfer instruction means 15 (see FIGS. 3, 4, 9, and 11 which will be described later).

The accumulated fund reference means 17 is means which generates predetermined accumulated fund information including the fund transfer result and then transmits the accumulated fund information such that this information can be referred to by the customer terminal 40 operable by the user. This accumulated fund reference means 17 constitutes accumulated fund information generating means according to the present invention.

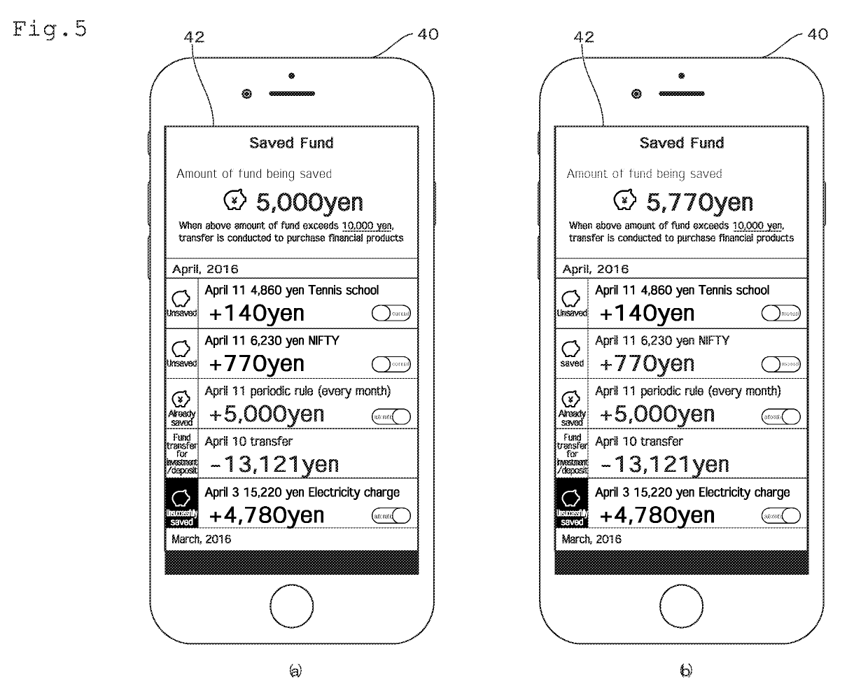

The accumulated fund information generated and output by the accumulated fund reference means 17 is predetermined information indicating, for example, the current amount of accumulated fund in the accumulation account of the financial institution apparatus 30 which performs the aforementioned transfer processing (see FIGS. 5, 10, and 12 which will be described later).

The specific function and operation of each means enabled by the fractional fund transfer and accumulation server 10 according to the present embodiment described above will be described later with reference to display screen examples output to and displayed in the customer terminal 40 (see FIGS. 2 to 13).

[Financial Institution Apparatuses 20 and 30]

The financial institution apparatuses 20 and 30 are, for example, information processing apparatuses provided in financial institutions such as a card company and a bank, and are connected to the fractional fund transfer and accumulation server 10 described above to permit data communication therewith.

In the example shown in FIG. 1, the financial institution apparatus 20 is an information processing apparatus disposed in the card company, and the financial institution apparatus 30 is an information processing apparatus disposed in the bank.

[Card Company]

The financial institution apparatus 20 disposed in the card company comprises a card usage details DB21 as storage means which stores usage details information for cards operated by the card company.

Information which is stored in the card usage details DB21 includes, for example, the attribute information for the user regarding each card managed and operated by the card company, and usage details information for this card indicating the date and time of usage, an amount of money used, the contents of usage, and others.

The usage details information held and managed by this card company is the “amount of money charged” according to the present invention which is used by the user to calculate a transfer amount of money to accumulate the target amount of money.

Here, cards operated by card companies include, for example, credit cards, traffic-related cards, distribution-related prepaid cards, various electronic money cards, and point cards.

Then the information which is stored in the card usage details DB21 is transmitted to the fractional fund transfer and accumulation server via a network, and stored in the account information DB as account information for each user.

[Bank]

The financial institution apparatus 30 disposed in the bank comprises a fund account DB31 as storage means which stores information for deposit accounts operated by the bank.

Information which is stored in the fund account DB31 includes, for example, the attribute information for the users regarding various deposit accounts (e.g. accounts for an ordinary deposit and a current deposit) managed and operated by the bank, and transaction information such as balances, histories of money payment and reception, and others in the deposit accounts.

This deposit account constitutes the “fund account” according to the present invention which is a transfer source from which the user transfers the fund to accumulate the target amount of money.

Furthermore, the amount of money charged to this deposit account indicated by the transaction information for the deposit account is the “amount of money charged” according to the present invention with which the user calculates a transfer amount of money to accumulate the target amount of money.

Here, the deposit accounts managed and operated by the bank include, for example, highly mobile deposit (savings) accounts such as an ordinary deposit, a current deposit, a savings deposit, and a normal deposit, and low mobile deposit (savings) accounts such as a time deposit, a notice deposit, and a cumulative deposit.

Further, an account that can be used as an account to be charged for cards, public utility charges, and others, specifically, the ordinary deposit or the current deposit is the “fund account” according to the present invention.

The information which is stored in the fund account DB31 is transmitted to the fractional fund transfer and accumulation server via a network, and stored in the account information DB as account information for each user.

Furthermore, the financial institution apparatus 30 comprises an accumulation account DB32 as storage means to store information for the “accumulation account” (fund saving account) according to the present invention that serves as the deposit account operated by the bank to which the user transfers the fund to accumulate the target amount of money.

The accumulation account is an account used to accumulate and save the transfer fund according to the present invention, and the account allocated to the accumulation account is an exclusive account in which the user can not conduct transactions to pay and withdraw money, such as a special deposit of the financial institution or a pool account for bond purchase. This savings account constitutes the “accumulation account” according to the present invention to which the user transfers the fund to accumulate the target amount of money.

The information which is stored in the accumulation account DB32 includes, for example, the attribute information for each user who uses this account, and transaction information such as balances, histories of money payment and reception, and others in the accumulation account of each user.

The transaction information which is stored in the accumulation account DB32 is “accumulated reference information” according to the present invention that indicates predetermined information including the transfer result of the fund to accumulate the target amount of money by the user.

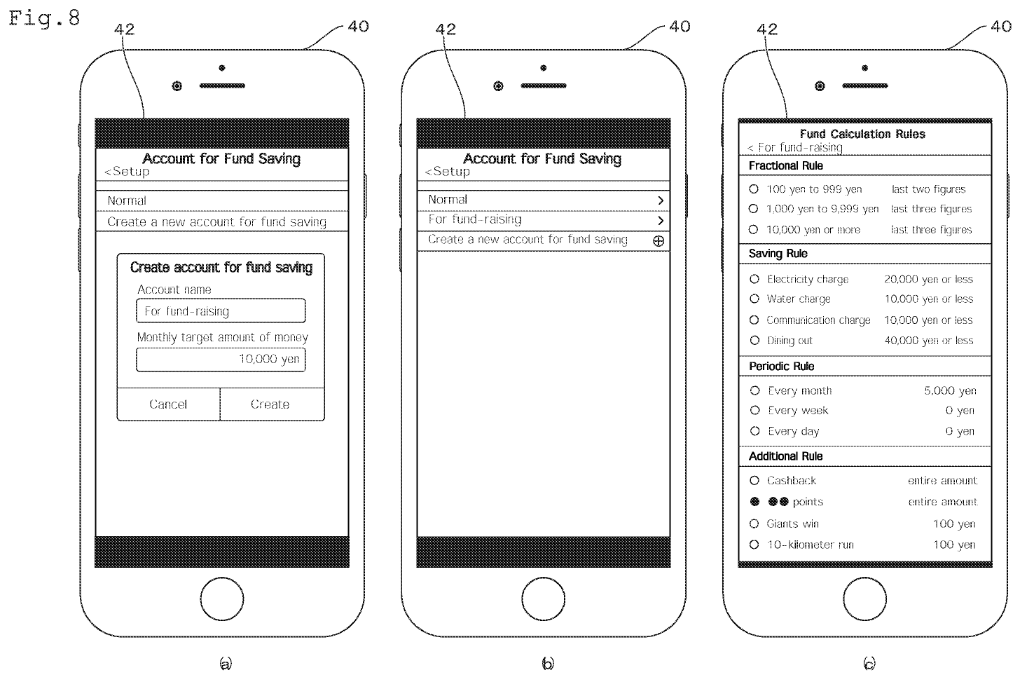

In addition, regarding the accumulation account described above, a single (one) user can set more than one savings account, as will be described later. Accordingly, for example, more than one accumulation account, such as a pure account for fund saving and an account for fund-raising, can be opened as accumulation accounts in accordance with the purposes of saving, target amounts of money, and targets for saving (see FIGS. 8 to 12 which will be described later), and more positive and forward-looking saving and economizing actions can be encouraged.

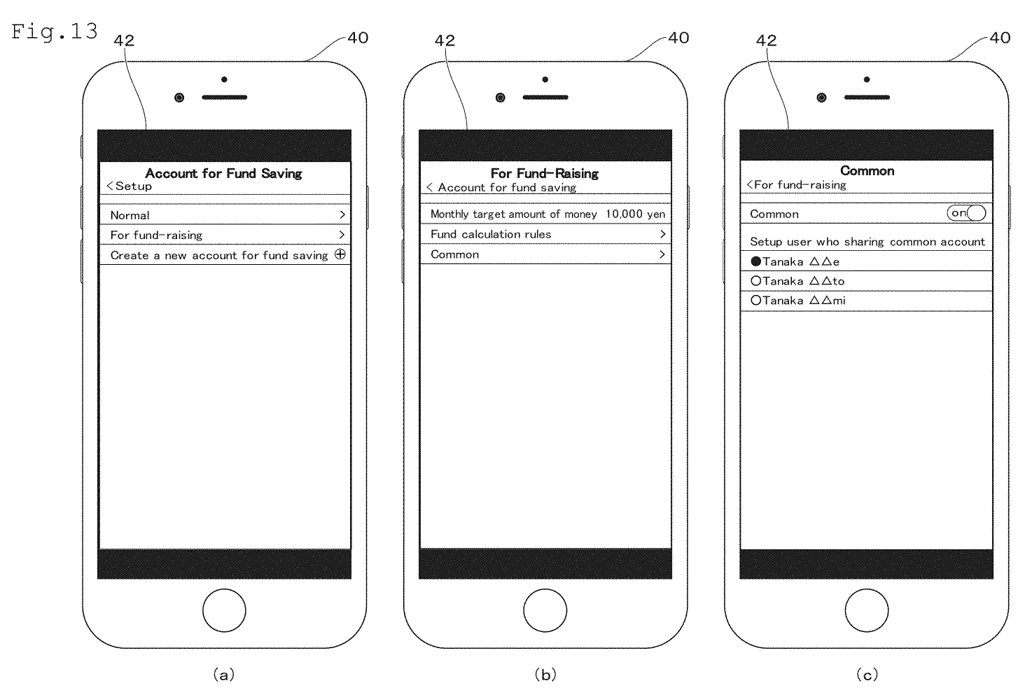

Moreover, more than one user can set one (common) accumulation account. Thus, for example, three members of a family can save fractional funds and saving funds in one accumulation account (see FIG. 13 which will be described later), which enables more efficient saving.

Furthermore, when the transfer amount of money in the accumulation account described above has reached a predetermined amount of money, the financial institution apparatus 30 can use the transfer fund to perform purchase processing (movement of the fund) for a predetermined financial product. The purchase processing for the financial product can be performed in the financial institution apparatus 30 automatically or after the receipt of approval or a request from the user.

Here, financial products which can be purchased with the transferred fund in the accumulation account (for which the fund can be moved) include, for example, a time deposit, a foreign currency deposit, an investment trust, and securities such as stock securities and a bond certificate.

In addition, regarding the purchase of the financial product (movement of the fund), while it is possible to purchase a financial product (e.g. a time deposit) sold by the same financial institution (bank) provided with the financial institution apparatus 30, it is also possible to purchase a financial product sold by a financial institution different from the financial institution provided with the financial institution apparatus 30, for example, another bank, a securities company, or a foreign bank. In this case, the transfer fund to be a purchase fund can be remitted or transferred to the different financial institution to purchase a desired financial product.

Each of the financial institutions comprising the financial institution apparatuses 20 and 30 described above can store and manage, by its own financial institution system or an external financial institution mission-critical system, information regarding investment products and load products sold by each of the financial institutions, the attribute information for the users of the financial institutions, account transaction history information, access history information, and card usage details information.

This financial institution system or financial institution mission-critical system functions as a counting-oriented and information-oriented information processing system owned by the corresponding financial institution.

In addition, the financial institution mission-critical system is composed of and operated by a huge server system group owned by an information system company that is known as a system integrator which receives a contract to operate a data system of one or two or more financial institutions in response to outsourcing thereof. Systems known as such a financial institution mission-critical system 50 are, for example, a securities mission-critical system (STAR (registered trademark)) operated by Nomura Research Institute, Ltd., and a financial product intermediation system (BESTWAY (registered trademark)) of banks.

[Customer Terminal 40]

The customer terminal 40 is an information processing apparatus available to the users (customers and investors) of the financial institutions (the bank and the card company) described above, and comprises, for example, smartphones, portable terminals, PCs, and tablets owned by the users, and PCs and dedicated terminal devices disposed at the financial institutions provided with the financial institution apparatuses 20 and 30.

The user can operate this customer terminal 40 to invoke the program provided by the fractional fund transfer and accumulation server 10, and execute and utilize the functions and services provided by the fractional fund transfer and accumulation system according to the present invention.

Specifically, the customer terminal 40 according to the present embodiment comprises fund calculation rules setting means 41 and display means 42.

The fund calculation rules setting means 41 is means which sets a target amount of money to be a saving target and predetermined fund calculation rules information in response to an input operation performed by the user via input means (e.g. a touch panel, a mouse, and a keyboard) of the customer terminal 40.

Here, the fund calculation rules information that can be set by the fund calculation rules setting means 41 includes, for example, a predetermined target amount of money which is a target for an amount of money to be saved, and various rules (e.g. the fractional rule, the saving rule, the periodic rule, and the additional rule) to achieve the target amount of money, as will be described later (see FIG. 2 which will be described later).

The display means 42 is a display unit or a display provided in the customer terminal 40, and comprises, for example, a touch panel display unit of a smartphone or a tablet, and a liquid crystal display connected to a PC. Predetermined accumulated fund information generated in the accumulated fund reference means 17 of the fractional fund transfer and accumulation server 10 described above is visibly displayed to the user via the display means 42.

Here, the accumulated fund information output and displayed in the display means 42 is predetermined information indicating the current amount of the accumulated fund in the accumulation account of the financial institution apparatus 30 which performs the aforementioned transfer processing indicated and executed in the fractional fund transfer and accumulation server 10 (see FIGS. 5, 10, and 12 which will be described later).

As above, the user according to the present embodiment can use the customer terminal 40 to access a Web application or the like provided by the fractional fund transfer and accumulation server 10 via the Internet or the like, and execute the functions of the fractional fund transfer and accumulation system according to the present invention.

However, the present invention is not limited to this configuration according to the present embodiment, and it is also possible to execute the functions of the fractional fund transfer and accumulation system according to the present invention by introducing and installing a dedicated software into the customer terminal 40 and then directly communicating with the financial institution apparatuses 20 and 30. In this case, the customer terminal 40 itself constitutes the fractional fund transfer and accumulation server 10.

Furthermore, it is also possible to directly execute the functions of the fractional fund transfer and accumulation system according to the present invention between the financial institution apparatus 30 and the customer terminal 40, for example, by introducing a dedicated software into the financial institution apparatus 30 of the bank. In this case, the financial institution apparatus 30 constitutes the fractional fund transfer and accumulation server 10.

[Fractional Fund Transfer and Accumulation Method]

Now, a specific processing operation (fractional fund transfer and accumulation method) of the fractional fund transfer and accumulation system 1 according to the present embodiment having the above configuration is described with reference to FIGS. 2 to 13.

First, as a prerequisite for the processing operation of the fractional fund transfer and accumulation system 1, predetermined fund calculation rules are set in the fractional fund transfer and accumulation server 10 from the customer terminal 40 in response to an input operation by the user.

FIG. 2 is an explanatory view showing one example of the “fund calculation rules” which are settable in the fractional fund transfer and accumulation server 10 according to the present embodiment.

[Fund Calculation Rules]

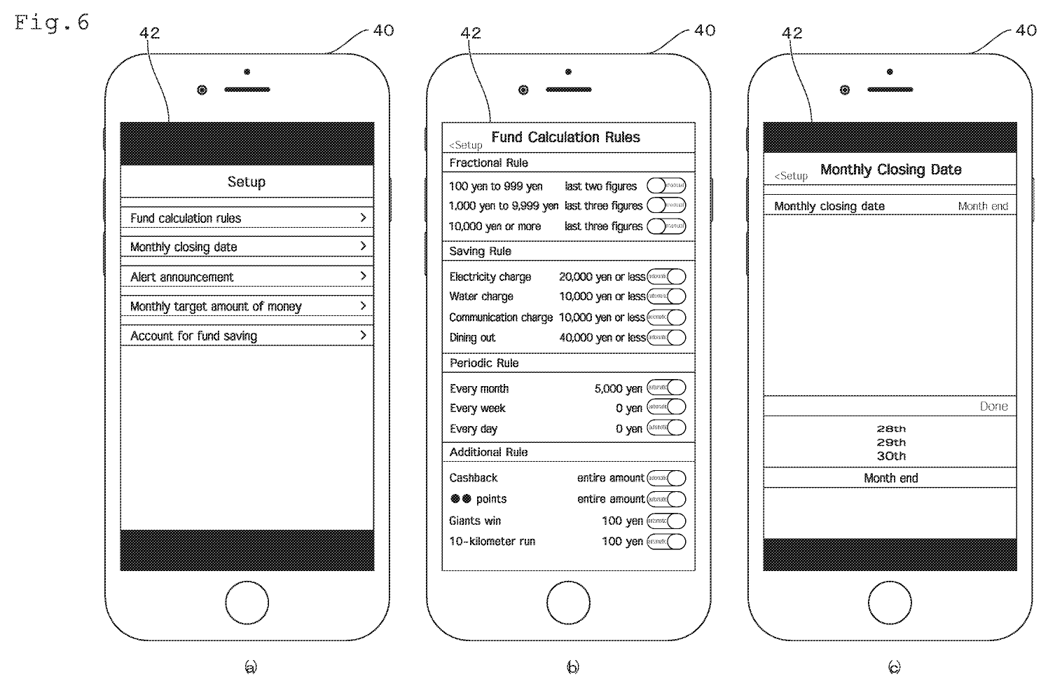

Regarding the setting of the fund calculation rules, the user opens a predetermined screen (see FIG. 6(b)) of the fund calculation rules on a dedicated application or a designated Website via the customer terminal 40 (e.g. a smartphone or a PC) operable by the user, and can perform various settings. The set fund calculation rules are stored in the fund calculation rules DB11 at the fractional fund transfer and accumulation server 10.

In the present embodiment, as shown in FIG. 2, the “fractional rule”, the “saving rule”, the “periodic rule”, and the “additional rule” as well as the desired “target amount of money” are set as the fund calculation rules.

Specifically, in the example shown in FIG. 2, the following “rules” can be set to achieve the predetermined “target amount of money”, and an amount of money calculated under the set rule is targeted as the “transfer fund” to be transferred to the accumulation account from the predetermined fund account, and the transfer processing is performed by an “automatic” or “manual” transfer mode.

[Fractional Rule]
Charge of 100 yen to 999 yen: last two figures of the difference between the charge and 1000 yen•manual
Charge of 1,000 yen to 9,999 yen: last three figures of the difference between the charge and 10,000 yen•manual
Charge of 10,000 yen or more: last three figures of the difference between the charge and a unit of 10,000 yen•manual

[Saving Rule]
Electricity charge: the difference between the charge and 20,000 yen•automatic
Water charge: the difference between the charge and 10,000 yen•automatic
Communication charge: the difference between the charge and 10,000 yen•automatic
Dining out: the difference between the charge and 40,000 yen•automatic

[Periodic Rule]
Every month: 5,000 yen•automatic
Every week: 0 yen•automatic
Every day: 0 yen•automatic

[Additional Rule]
Cashback: entire amount•automatic
OO point: entire amount•automatic
Giants win: 100 yen•automatic
100-kilometer race: 100 yen•automatic

The “fund calculation rules” described above are set so that if the user first uses a card in daily shopping of the like and a bill is then charged to an account under the “fractional rule”, a fraction equivalent to a change which is made when payment is made in cash (bills) is calculated by the fund calculation means 13, and this amount of money is transferred as the transfer fund to the accumulation account from the fund account. For example, when “4,860 yen” is charged, the fund calculation means 13 performs computation processing “5,000 yen−4,860 yen=140 yen”, and calculates a transfer fund of 140 yen.

In addition, the card usage and charging are referred to and judged by the fund calculation means 13 on the basis of the card usage details information transmitted from the financial institution apparatus 20 of the card company.

Furthermore, under the “saving rule”, the difference between heating and lighting costs such as the electricity charge as well as public utility charges or dining out or the like and a set amount of money is calculated as saved money in the fund calculation means 13, and this amount of money is transferred as the transfer fund to the accumulation account from the fund account. For example, “20,000 yen” is set as a set amount of money for the electricity charge, and “15,220 yen” is charged as the electricity charge in a certain month, the fund calculation means 13 performs computation processing “20,000 yen−15,220 yen=4,780 yen”, and calculates a transfer fund of 4,780 yen.

Therefore, for example, when the amount of money charged as the electricity charge is over the set amount of money (20,000 yen), no transfer fund is calculated, and the transfer processing is not performed.

In addition, the charges for the heating and lighting costs and public utility charges are referred to and judged by the fund calculation means 13 on the basis of the charge information transmitted from the financial institution apparatus 30 of the bank, or the card usage details information transmitted from the financial institution apparatus 20 of the card company when the card is used.

Moreover, the charge for dining out is judged on the basis of the card usage details information described above. For example, when an industry code can be acquired from the card usage details information of the card company, the industry code can be used for judgment. When there is no industry code, it is also possible to judge by the name of, for example, a store. In addition, the user can designate details to be classified to dining out from the existing card details.

Furthermore, when the “periodic rule” is set, a predetermined fixed amount of money set by the user can be transferred to the accumulation account at every predetermined period, such as every month, every week, or every day.

This is substantially similar to the existing cumulative deposit. However, a small amount is accepted, and a short period can be set by comparison with the cumulative deposit, so that the advantage is that there is a higher degree of freedom in the amount of money and period, and the user can steadily save small funds to a reasonable extent.

Furthermore, as the “additional rule”, cashbacks or point-giving services can be considered unreceived, and totally transferred to the accumulation account.

Moreover, the user can set any rule, and when a predetermined event occurs, for example, when a favorite sport team (e.g. Giants or Urawa Reds) wins, the user can save a certain amount of money (e.g. 100 yen), and can have the advantage of having the fun of saving.

In addition, whether or not such an event has occurred can be determined, for example, by the input of the corresponding event information from a news site on the Internet.

Furthermore, when the user has achieved, for example, some objective (e.g. the user has run 10 kilometers) as the predetermined event corresponding to the “additional rule”, the user can save a certain amount of money (e.g. 100 yen) as his/her own reward (remuneration). Thus, it is possible to further increase the joy of saving in addition to the user's sense of achievement of the objective of running or the like.

In addition, the distance in which the user has run can be measured by use of a device such as a wearable terminal or a smartphone terminal which can recognize running, and the measured distance data can be acquired from the application of the fractional fund transfer and accumulation server 10.

Furthermore, the “manual” or “automatic” mode can be selectively set as a transfer mode for the transfer of the fund based on the rules set as described above.

In the case where the transfer mode of the fund is set to “manual”, if an amount of money to be a transfer target is extracted, it is displayed that this amount of money is the transfer target, and a transfer instruction is given by the fund transfer instruction means 15 in response to an input operation by the user (see FIGS. 5, 10, and 12 which will be described later). Therefore, the user can determine not to perform the transfer processing, for example, depending on the fund status (financial condition).

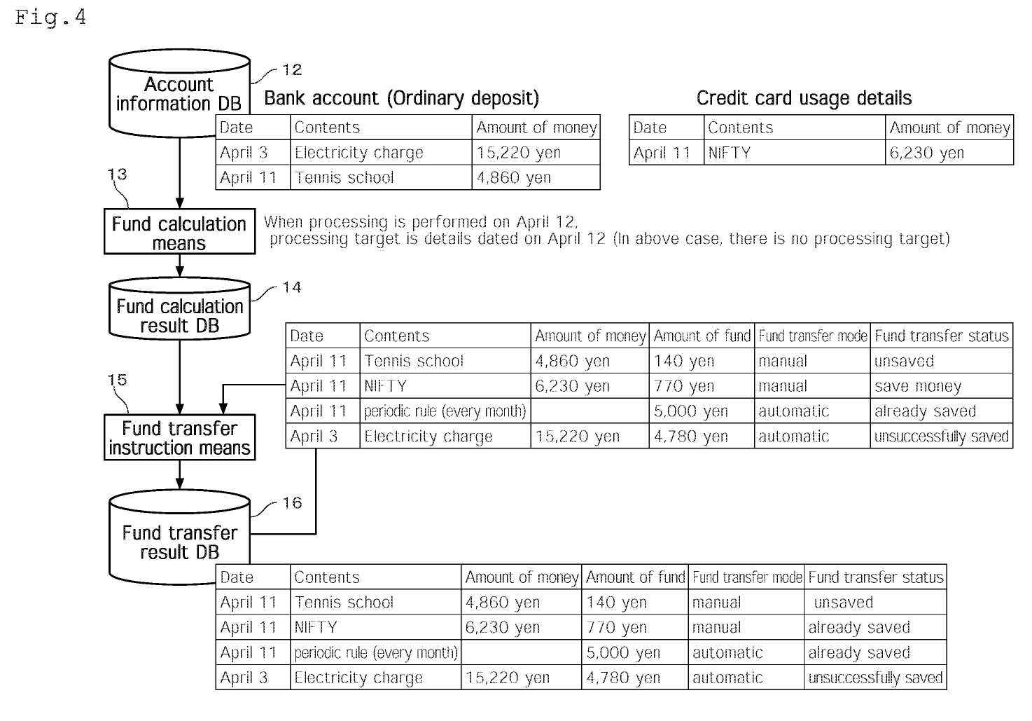

In this case, the fund transfer status is “unsaved” until the “manual” operation is performed by the user. The fund transfer status becomes “already saved” when the transfer processing is performed by the “manual” operation. The fund transfer status becomes “unsuccessfully saved” when the transfer processing is not performed because of an insufficient balance in the account (see FIGS. 3 and 4 which will be described later).

On the other hand, in the case where the transfer mode of the fund is set to “automatic”, if an amount of money to be a transfer target is extracted, a transfer instruction is automatically given by the fund transfer instruction means 15. In this case, when the balance in the fund account of the bank is insufficient, the transfer processing is not performed, and a predetermined notification (e.g. an alert announcement) indicating the fact can be given. Moreover, in the case of “automatic”, the processing target for the extraction of an amount of money to be a transfer target is a charge record of the bank account or a record of credit card usage details, and it is possible to extract from the contents (a charge subject, a details subject) or extract from the name of a payee company. Here, the contents may be classified from the contents or the name of the payee company, and whether or not to target for extraction may be determined by the classified contents.

In this case, the fund transfer status becomes “already saved” when the transfer processing is “automatically” performed, and the fund transfer status becomes “unsuccessfully saved” when the transfer processing is not performed because of an insufficient balance in the account (see FIGS. 3 and 4 which will be described later).

[Operation]

One example of the operation of the fractional fund transfer and accumulation system 1 according to the present embodiment in the case where the “fund calculation rules” described above are set is described with reference to FIGS. 3 and 4.

FIGS. 3 and 4 are explanatory views showing one example of the operation of the fractional fund transfer and accumulation system 1 according to the present embodiment.

First, in the fractional fund transfer and accumulation server 10, as shown in FIG. 3, information regarding bank accounts and card usage details stored in the account information DB12 is periodically referred to, a fund calculation is performed in the fund calculation means 13 under the fund calculation rules set in the fund calculation rules DB11, and the fund calculation result is output to and stored in the fund calculation result DB14.

In addition, regarding the account information stored in the account information DB12, necessary information is transmitted from the financial institution apparatus 20 of the card company and the financial institution apparatus 30 of the bank at a predetermined timing (e.g. daily processing), and the information in the account information DB12 is updated.

In the example shown in FIG. 3, a processing operation on April 11 is shown. As the account information from the financial institution apparatus 30 of the bank, charge information “April 3: electricity charge•15,220 yen” and “April 11: tennis school•4,860 yen” are transmitted as transactions in the ordinary deposit account of the user. Further, as the card usage details information from the financial institution apparatus 20 of the card company, usage details information “April 11: NIFTY•6,230 yen” is transmitted. Each piece of information is stored as the account information in the account information DB12.

In this state, fund calculation processing by the fund calculation means 13 is performed at a predetermined timing (e.g. every day, twice a day).

In the fund calculation processing, predetermined calculation processing is performed with reference to the preset “fund calculation rules” described above.

In the example shown in FIG. 3, as the fund calculation processing for April 11, “amount of fund: 140 yen•fund transfer mode: manual•fund transfer status: unsaved” is calculated and judged with regard to “April 11: tennis school•4,860 yen”, and “amount of fund: 770 yen•fund transfer mode: manual•fund transfer status: unsaved” is calculated and judged with regard to “April 11: NIFTY•6,230 yen”.

Moreover, under the “fund calculation rules”, “April 11: periodic rule (every month)•amount of fund: 5,000 yen•fund transfer mode: automatic•fund transfer status: unsaved” is calculated and judged.

This calculation result in the fund calculation means 13 is stored in the fund calculation result DB14.

Fund transfer instruction information is then transmitted to the financial institution apparatus 30 of the bank by the fund transfer instruction means 15 on the basis of the fund calculation result information stored in the fund calculation result DB14.

This fund transfer instruction targets, for processing, details in which the fund transfer mode of the fund calculation result DB14 is set to “automatic”, or the fund transfer status is set to “save money” (see FIG. 4).

When the fund transfer mode is set to “manual”, the fund transfer instruction is not transmitted until the manual operation by the user is performed.

When the fund transfer instruction is transmitted, the target financial institution apparatus 30 performs the transfer processing to a different account (accumulation account) in the bank to the extent that the balance in the corresponding fund account (e.g. the ordinary deposit account) does not become insufficient.

After the transfer instruction is transmitted to the financial institution apparatus 30, the result of the transfer instruction is then transmitted at a predetermined timing, and acquired in the fractional fund transfer and accumulation server 10, and this information is stored in the fund transfer result DB16.

In addition, the result of the transfer processing from the financial institution apparatus 30 is transmitted in real time simultaneously with the execution of the transfer processing, or a notification can be received from the financial institution apparatus 30 at a predetermined timing after the end of the transfer processing of the financial institution. Moreover, until the transfer result is acquired from the financial institution apparatus 30, the fund transfer status at the fractional fund transfer and accumulation server 10 remains “unsaved”.

In the example shown in FIG. 3, regarding “April 11: tennis school•4,860 yen•amount of fund: 140 yen•fund transfer mode: manual” and “April 11: NIFTY•6,230 yen•amount of fund: 770 yen•fund transfer mode: manual”, no fund transfer instruction is given, and the fund transfer status remains “unsaved”.

On the other hand, regarding “April 11: periodic rule (every month)•amount of fund: 5,000 yen•fund transfer mode: automatic”, the fund transfer instruction is given, and as a result, the fund transfer status is “already saved”.

Furthermore, as shown in FIG. 3, regarding “April 3: electricity charge•15,220 yen•amount of fund: 4,780 yen•fund transfer mode: automatic”, the fund transfer status is “unsuccessfully saved”, which proves that the transfer processing is not performed because of an insufficient balance in the account.

Thus, in accordance with the transfer result from the financial institution apparatus 30, the information indicating the fund transfer status is changed to “already saved” when the transfer is successful, and the information is changed to “unsuccessfully saved” when the transfer is unsuccessful. Information after this change is stored and updated in the fund transfer result DB16 as the fund transfer result information.

The transfer result can be displayed and checked on a screen of the display means 42 of the customer terminal 40 after the end of the transfer processing (see FIG. 5).

Then the aforementioned fund transfer status “unsaved” or “unsuccessfully saved” can be changed to “save money” on the screen of the customer terminal 40. When the fund transfer status is changed to “save money”, the processing target for the next fund transfer instruction is set, and “save money” is stored and updated as input data for the fund transfer instruction.

This is described with reference to FIG. 4.

FIG. 4 shows an example of a case where the fund transfer status is changed to “save money” on April 12 which is the day after the processing shown in FIG. 3.

First, in the processing on April 12 shown in FIG. 4, there is no change in the account information in the account information DB12, and the calculation processing in the fund calculation means 13 is not performed either. Therefore, there is no change in the data stored in the fund calculation result DB14 either.

In this state, the user operates the customer terminal 40 to change the fund transfer status to “save money” with regard to “April 11: NIFTY•6,230 yen•amount of fund: 770 yen•fund transfer mode: manual•fund transfer status: unsaved” shown in FIG. 3.

Thus, when the customer terminal 40 changes the fund transfer status “unsaved” (or “unsuccessfully saved”) to “save money”, the information stored in the fund transfer result DB16 is updated.

Then the fund transfer instruction means 15 extracts the corresponding “April 11: NIFTY•6,230 yen•amount of fund: 770 yen” as the processing target for the fund transfer instruction at a predetermined processing timing, and transmits the fund transfer instruction to the financial institution apparatus 30.

In the financial institution apparatus 30 to which the fund transfer instruction is transmitted, transfer processing to the accumulation account from the corresponding fund account is performed, and the transfer instruction result is transmitted to the fractional fund transfer and accumulation server 10.

Accordingly, the information in the fund transfer result DB16 is updated.

In the example shown in FIG. 4, it can be seen that the fund transfer status of “April 11: NIFTY•6,230 yen•amount of fund: 770 yen•fund transfer mode: manual” is updated to “already saved” from “unsaved”.

Furthermore, the result of the fund transfer processing performed as described above is generated as accumulated fund information by the accumulated fund reference means 17 in response to a reference request from the customer terminal 40, and can be displayed and accessed in the display means 42 of the customer terminal 40.

FIG. 5 shows one example of display screens of the accumulated fund information displayed in the display means 42 of the customer terminal 40 according to the present embodiment, wherein (a) shows accumulated fund information at a point corresponding to FIG. 3, and (b) shows accumulated fund information at a point corresponding to FIG. 4.

In the example shown in FIG. 5(a), “amount of fund being saved: 5,000 yen” at present and the target amount of money “10,000 yen” are shown, “unsaved” is shown with regard to “April 11•4,860 yen•tennis school•+140 yen”, “unsaved” is shown with regard to “April 11•6,230 yen•NIFTY•+770 yen”, and “already saved” is shown with regard to “April 11•periodic rule (every month)•+5,000 yen”.

It is also shown that “−13,121 yen” is transferred as the fund to purchase a financial product (the fund is transferred to the financial product) on the previous day April 10.

Further, “unsuccessfully saved” is shown with regard to “April 3•15,220 yen•electricity charge•+4,780 yen”.

On the other hand, in the example shown in FIG. 5(b), which is, however, substantially similar to the screen in FIG. 5(a), it can be seen that the display is changed to “already saved” from “unsaved” with regard to “April 11•6,230 yen•NIFTY•+770 yen”, and there is an increase in the “amount of fund being saved: 5,770 yen” at present.

Thus, the user can access and refer to the current accumulated fund and the status of the transfer processing as needed via the customer terminal 40 which is operated by the user, and can change the fund transfer status.

For the change of the fund transfer status, the setting can be switched between “unsaved” and “save money” by a tap operation or the like of an icon display of “unsaved” shown in FIG. 5(a).

Similarly, the setting can be switched to “save money” by a tap operation or the like of an icon display of “unsuccessfully saved”.

Further, regarding the fund transfer status “manual” or “automatic” shown in FIGS. 5(a) and (b) as well, the setting can be switched between “automatic” and “manual” by a tap operation or the like.

Although not particularly shown in FIGS. 3 to 5 above, when “electricity charge: 20,000 yen or less” is set as the aforementioned “saving rule” (see FIG. 2), a predetermined alert can be given if the electricity charge for the month comes close to 20,000 yen (e.g. if the electricity charge exceeds 80% (16,000 yen) of the set amount of money). For the alert announcement, predetermined characters or a caution indication can be displayed in the item “electricity charge” in the display screen.

For example, a default value can be previously set for the timing of the alert announcement at the fractional fund transfer and accumulation server 10, and if necessary, the user can change the timing in a setting screen on a dedicated application or a designated Website. It is also possible to set “no” alert announcement.

Furthermore, as described above, for example, when a target amount of money to be saved for the month is set, an alert announcement can be also given even if the target amount is unlikely to be reached. Whether or not the target amount is likely to be reached can be estimated and determined, for example, by the comparison with the previous-month achievements.

When the target amount of money to be saved is achieved in an early stage in succession, a predetermined message can be given to lower the set amount of money. For example, when there are a succession of a predetermined number (e.g. three) of months in which 100% of the set amount of money is reached before 20th of the month, the past achievements are displayed, and a predetermined amount of money is added to the current target amount of money to set a new target amount of money so that a message such as “Why don't you try a target amount of money of 15,000 yen?” is displayed, whereby more efficient saving that conforms to the user's fund status can be proposed.

Furthermore, when the transfer amount of money in the accumulation account of the financial institution apparatus 30 reaches the predetermined amount of money by the processing operation of the fund transfer described above, the purchase processing (movement of the fund) for a predetermined financial product is performed with the transferred fund.

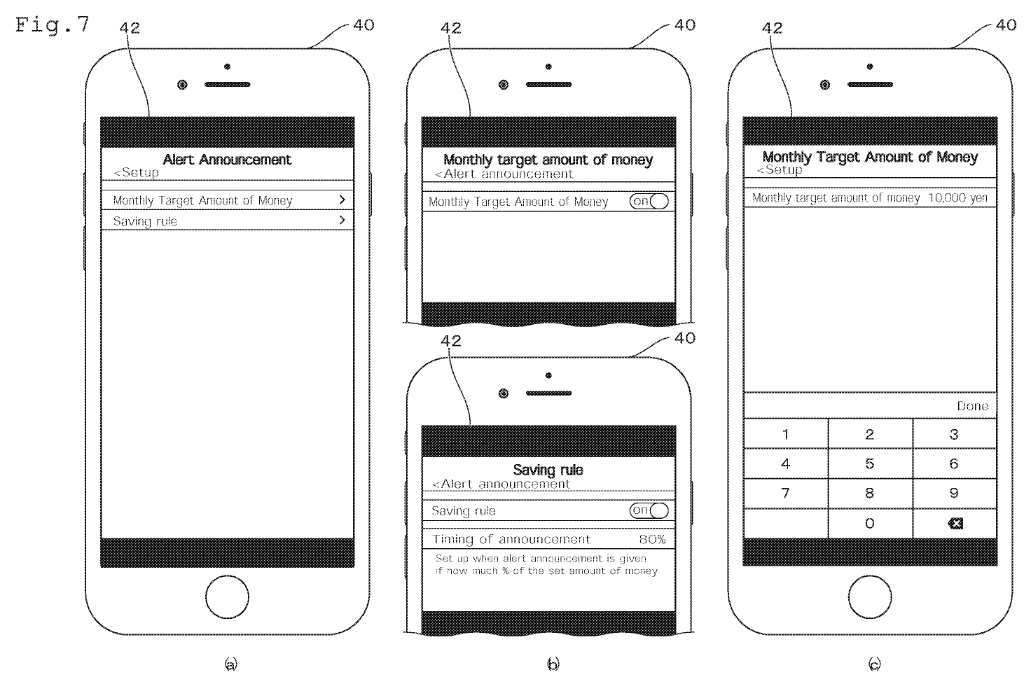

Regarding the purchase of this financial product, the purchase (movement of the fund) of a predetermined financial product can be made, for example, once a month when the amount of money in the accumulation account on the set “monthly closing date” (see FIG. 6(c)) is greater than a “monthly target amount of money to be saved” (see FIG. 7(c)).

Thus, the user can shift the accumulated fund saved by daily fractional funds and saving funds to financial products whereby more advantageous dividends and returns can be obtained, and efficient asset management and the like is achieved.

[Setting Display Screen]

Now, one example of an input display screen for setting items for the fractional fund transfer and accumulation server 10 which can be input and set at the customer terminal 40 in the above fractional fund transfer and accumulation system 1 is shown in FIGS. 6 and 7.

FIG. 6(a) shows a screen which selectably displays various setting items settable in the fractional fund transfer and accumulation server 10.

As shown in FIG. 6(a), from this screen, each of the items “fund calculation rules”, “monthly closing date”, “alert announcement”. “monthly target amount of money”, and “account for fund saving” can be selected, and each of the details can be set.

FIG. 6(b) shows a setting screen of the “fund calculation rules”.

From this screen, it is possible to select and set the necessity of each of the items “fractional rule”, “saving rule”, “periodic rule”, and “additional rule” as the above “fund calculation rules”, and the fund transfer mode “manual” or “automatic” for each item.

FIG. 6(c) shows a setting screen of the “monthly closing date”.

From this screen, it is possible to set a reference date on which monthly closing processing for the saved fund transferred to the accumulation account is performed, and “month end” is selected and set as the monthly closing date in FIG. 6(c).

FIG. 7(a) shows a setting screen of the “alert announcement”.

As shown in FIG. 7(a), in the present embodiment, setting can be performed for each of “monthly target amount of money” and “saving rule” in the case where the “alert announcement” is given.

When the “alert announcement” is set to “monthly target amount of money” (see FIG. 7(b)), a predetermined alert announcement can be given if it is estimated and determined that this amount of money is unlikely to be reached. When the “alert announcement” is set to “saving rule”, a predetermined alert announcement can be given if a predetermined ratio (e.g. 80% of the set amount of money) of a high limit (an amount of money to be saved) set as “saving rule”, for example, “electricity charge: 20,000 yen or less” or “dining out: 40,000 yen or less” is reached (see FIG. 7(b)).

FIG. 7(c) shows a setting screen of the “monthly target amount of money to be saved”.

From this screen, it is possible to set the “monthly target amount of money to be saved” (the target amount of money according to the present invention) of the fund which is transferred to the accumulation account by use of the fractional fund transfer and accumulation system 1.

[Multiple Accounts Setting]

In the fractional fund transfer and accumulation system 1 according to one embodiment of the present invention described above, a single (one) user can set more than one accumulation account as accumulation accounts to save transfer funds.

FIG. 8 shows one example of display screens to set more than one accumulation account from the setting screen of the customer terminal 40. FIG. 8(a) shows a case where “create a new account for fund saving” is selected in the setting screen of the “account for fund saving” selected in FIG. 6(a). FIG. 8(b) shows a screen in the case where an account for “fund-raising” is created as a result. FIG. 8(c) shows a setting screen of the account for “fund-raising” which is selected and set in (b).

As a result of such setting from the customer terminal 40, more than one accumulation account are allocated to, for example, a special deposit and a pool account in the financial institution.

In the example shown in FIG. 8, the account for “fund-raising” is opened in addition to the main “normal” account as the “account for fund saving”, and the transfer processing is “automatically” performed for the account for “fund-raising” when predetermined points (OO points) are given.

Thus, in the present embodiment, more than one accumulation account such as the pure “normal” account for fund saving and the account for “fund-raising” can be opened in accordance with the purposes of saving, target amounts of money, and targets for saving, and various savings and economizations can be performed.

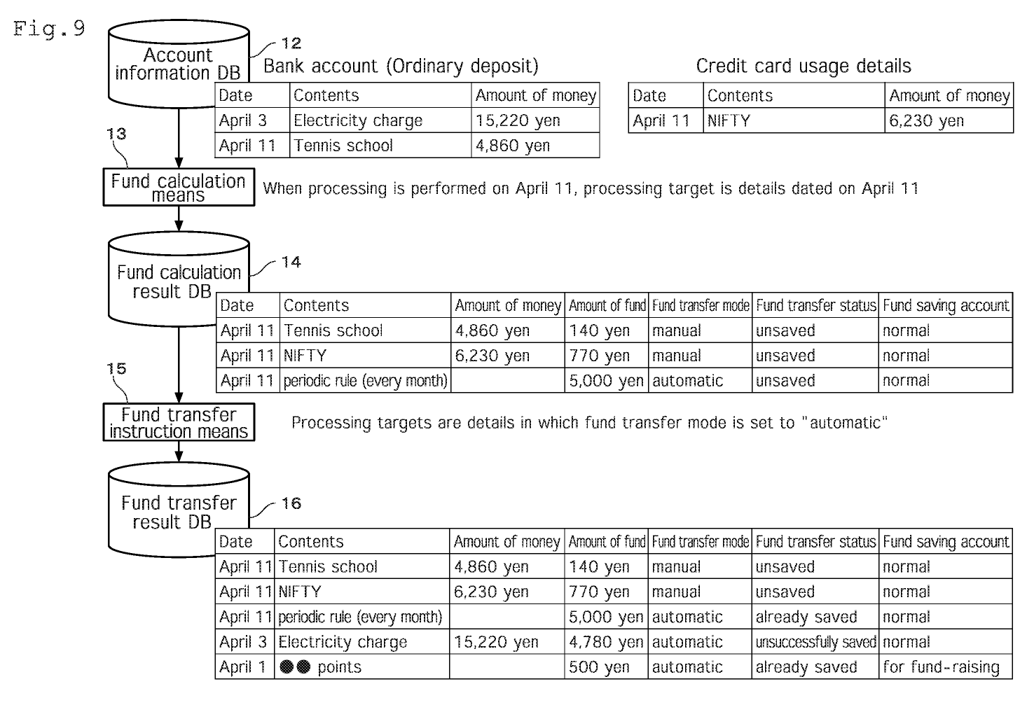

A transfer processing operation in the case where two “normal” and “fund-raising” accounts are set as accumulation accounts is described below with reference to FIGS. 9 to 12.

FIG. 9 shows a case where a charge transaction corresponding to FIG. 3 described above is conducted when the account for “fund-raising” is set in addition to the “normal” account. In comparison with the case in FIG. 3, information (item) about which accumulation account is designated is added to each charge transaction.

That is, in the example of FIG. 9, a banking transaction and card usage similar to those in the case of FIG. 3 described above are performed so that processing is performed with the “fund saving account: normal” with regard to each of the charge transactions “April 11: tennis school•4,860 yen•amount of fund: 140 yen”, “April 11: NIFTY•6,230 yen•amount of fund: 770 yen”, “April 11: periodic rule (every month)•amount of fund: 5,000 yen”, and “April 3: electricity charge•15,220 yen•amount of fund: 4,780 yen”.

In addition, it can be seen that regarding “April 1: OO points•500 yen”, “fund saving account: for fund-raising” is set so that the total amount is automatically transferred to the account for “fund-raising”.

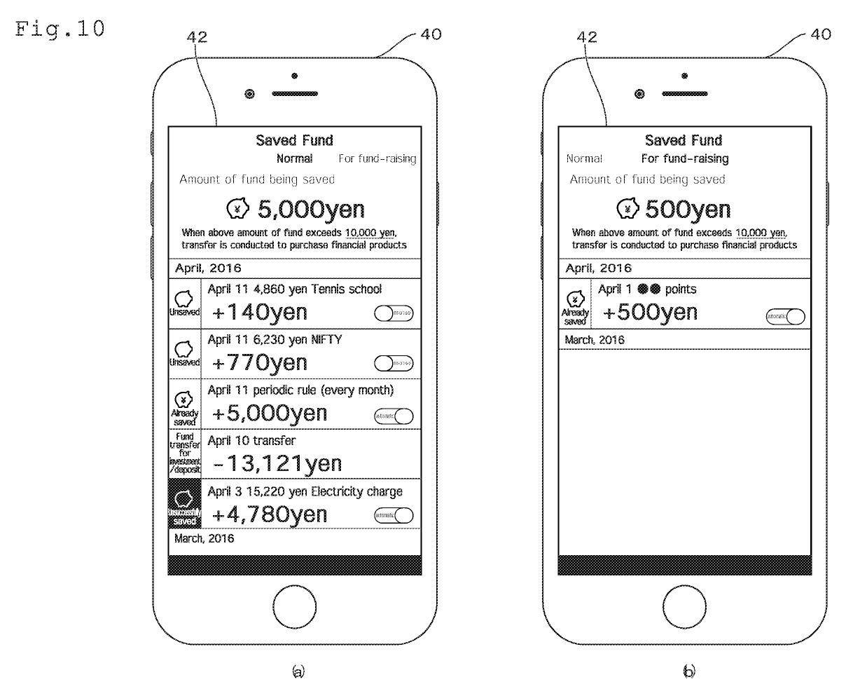

This transfer result can be displayed and checked on the screen of the display means 42 of the customer terminal 40 (see FIG. 10).

FIG. 10(a) shows a saving status in the “normal” account as of April 11, which is similar to the contents shown in FIG. 5(a) described above.

On the other hand, FIG. 10(b) shows a saving status in the account for “fund-raising” as of April 11 which is the same date, and shows that “April 1: OO points+500 yen” is “already saved” by “automatic” processing.

In addition, the display screens (accumulated fund reference information) of the “normal” account and the account for “fund-raising” can be switched by, for example, a swipe operation of a predetermined part on the display screen (character parts “normal” and “fund-raising” in the upper part of the display screen in FIG. 10).

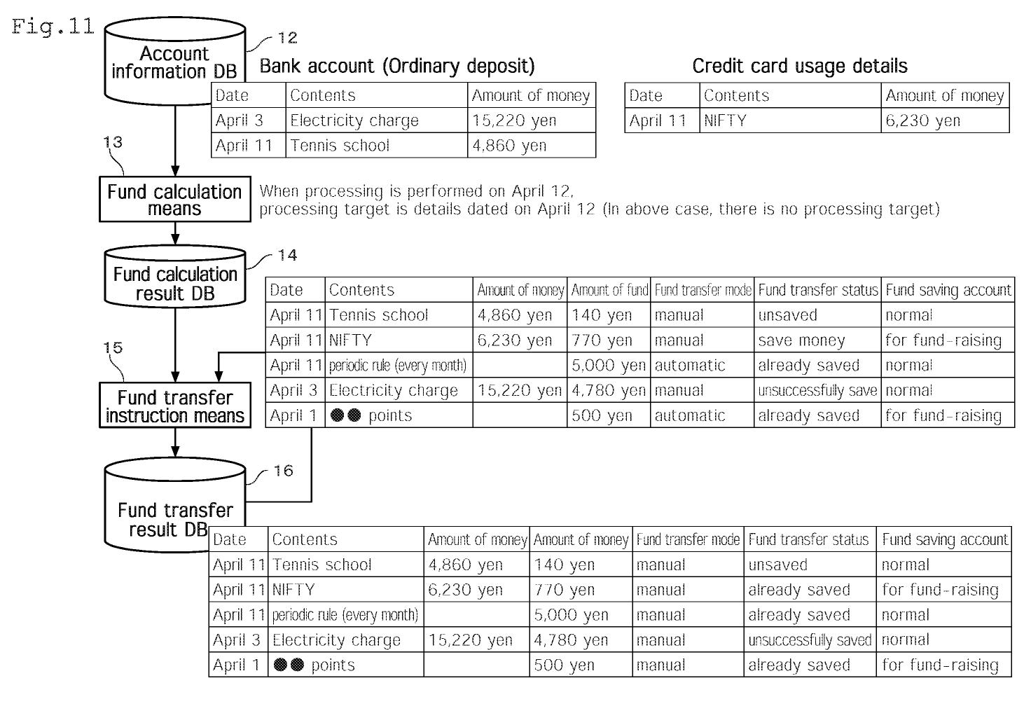

FIG. 11 shows a case where the charge transaction corresponding to FIG. 4 described above is conducted when the account for “fund-raising” is set in addition to the “normal” account.

In the example shown in FIG. 11, when a banking transaction and card usage similar to those in the case of FIG. 4 described above are performed, the fund transfer status is changed to “save money”, and the accumulation account to be designated is changed to “fund-raising” from “normal”, with regard to “April 11: NIFTY•6,230 yen•amount of fund: 770 yen•fund transfer mode: manual•fund transfer status: unsaved” shown in FIG. 9.

Regarding the change of the accumulation account, for example, in the case of a change from “unsaved” to “save money”, either the “normal” or “fund-raising” account can be selected by the formation and display of a display screen in which the account to be used can be selected.

Thus, it is possible to change from “unsaved” to “save money” and select and change the account to be designated, by an input operation from the customer terminal 40. Consequently, more flexible and diverse saving patterns and economizing patterns can be provided.

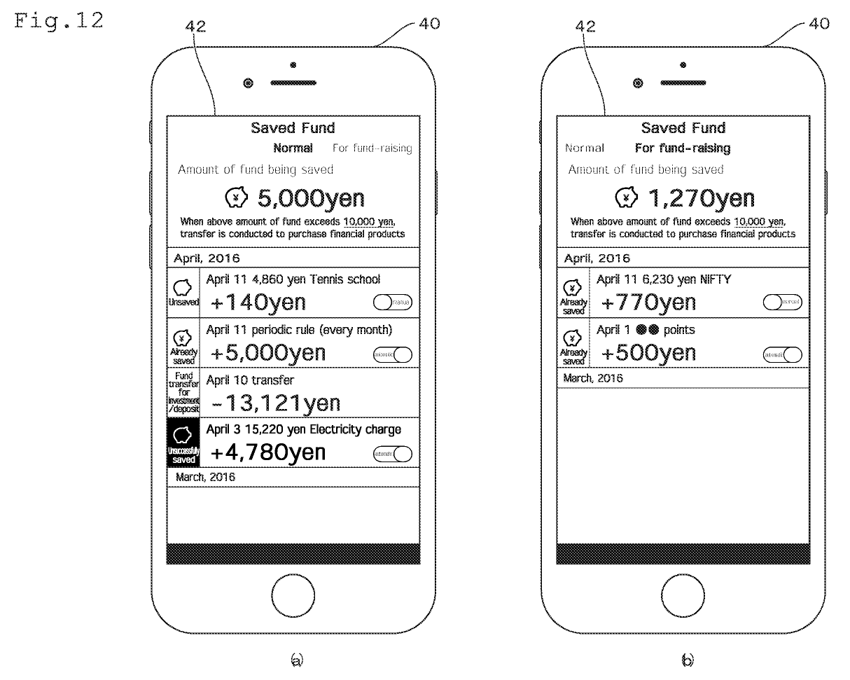

In addition, this transfer result can be also displayed and checked on the screen of the display means 42 of the customer terminal 40 (see FIG. 12).

FIG. 12(a) shows a saving status in the “normal” account as of April 12, which is similar to the contents shown in FIG. 5(a) described above.

On the other hand, FIG. 12(b) shows a saving status in the account for “fund-raising” as of April 12 which is the same date. “April 11•6,230 yen•NIFTY•+770 yen” is “already saved” by “manual” processing in addition to “April 1: OO points+500 yen”, and an increase in the “amount of fund being saved: 1,270 yen” can be checked and referred to.

[Common Account Setting]

As described above, in the fractional fund transfer and accumulation system 1 according to the present embodiment, a single user can set more than one account as accumulation accounts for saving.

Moreover, in the present embodiment, more than one user can set one (common) accumulation account.

For example, three members of a family can save fractional funds and saving funds in one accumulation account.

FIG. 13 shows one example of display screens in the case where one accumulation account shared by more than one user is set from the setting screen of the customer terminal 40. FIG. 13(a) shows a case where “create a new account for fund saving” is selected in the setting screen of the “account for fund saving” selected in FIG. 6(a). FIG. 13(b) shows a screen in the case where a “common” account is created as a result. FIG. 13(c) shows a setting screen of the “common” account which is selected and set in (b).

As a result of such setting from the customer terminal 40, more than one user are allocated to, for example, one accumulation account set to a special deposit and a pool account in the financial institution.

In the example shown in FIG. 13, the “common” account is opened in addition to the “normal” account and the account “for fund saving” described above, and three users are set to the “common” account.

Thus, by having the “common” accumulation account according to the present embodiment, it is possible to collectively save and accumulate, in one accumulation account, the fractional amounts of money, the amounts of money to be saved, and others produced in the banking transactions and card usage by the multiple (three) users, which enables more efficient saving and asset formation.

The number of users that can be set to the “common” account, and attributes or the like that can be shared are not limited in particular, and it is possible to hold the common account among the number of users or the users having attributes set by the financial institution.

As described above, according to the present embodiment, the user sets any fund calculation rules in the fractional fund transfer and accumulation server 10 so that fractional amounts of money calculated on the basis of the user's daily payments and the like can be transferred as saved money to a target saving fund.

In particular, different rules such as the fractional rule, the saving rule, the periodic rule, and the additional rule are settable as the fund calculation rules so that the user can carry out efficient and continuous saving to a reasonable extent.

It is also possible to naturally encourage and induce a positive saving action by rule setting that can restrain the user's expenditures and promote the concept of saving; for example, promote hold-down of heating and lighting costs and dining out, and restrain favorite events and rewards to the user himself/herself.

Therefore, it is possible to flexibly adapt to diverse needs, consuming patterns, and life patterns of individual users when giving, for example, advice for personal asset management in particular, and at the same time provide a service suitable for the saving of funds to purchase financial products.

Thus, according to one embodiment of the fractional fund transfer and accumulation system of the present invention, it is possible to flexibly adapt to diverse needs of various individual users, and realize Fin Tech which can make suitable proposals to, for example, personal investors who are considering specific and planned asset management, investment plans, and the like that conform to daily life cycles in particular.

In addition, in the case shown in the present embodiment described above, the display screens output and displayed at the customer terminal 40 are displayed in display means of a relatively small screen, such as a display of a smartphone or a mobile telephone (FIGS. 5 to 8, 10, 12, and 13).

However, it should be understood that the display screens generated and displayed in the present invention can also be displayed in display means of a relatively large screen, such as display means of a PC or a tablet terminal.

While the preferred embodiment has been shown above to describe the present invention, it goes without saying that the present invention is not limited to the embodiment described above, and various modifications can be made within the scope of the present invention.

For example, although the “fractional rule”, the “saving rule”, the “periodic rule”, and the “additional rule” are shown as the “fund calculation rules” according to the present invention in the embodiment described above, these rules are only examples of the “fund calculation rules”, and are not restrictive. That is, some or all of the “fractional rule”, the “saving rule”, the “periodic rule”, and the “additional rule” described above can be used as the “fund calculation rules” according to the present invention, and rules different from the above rules can be added or substituted. As the “fund calculation rules” according to the present invention, it is possible to use any rules, conditions, or the like that stimulate the user's consciousness of saving and will to invest so that the user efficiently carries out continuous saving.

Furthermore, the fractional fund transfer and accumulation server and the financial institution apparatuses are configured as separate and independent apparatuses in the embodiment described above, but can be configured by a single (common) apparatus or system.

In this case, the fractional fund transfer and accumulation system according to the present invention is obtained as a part of the financial institution apparatus provided in the financial institution.

Moreover, the bank is shown as a specific example of the financial institution which provides the fund account and the accumulation account according to the present invention in the embodiment described above, the financial institution is not particularly limited to the bank.

The financial institution that can provide an account used to charge for the user's daily consumption and payments may be, for example, a post office, a trust bank, a credit association, or a credit union instead of the bank.

Further, the financial institution that can provide the accumulation account to which funds are transferred may also be a post office, a trust bank, a credit association, or a credit union as above, or may be a securities company or an investment company.

Furthermore, the financial institution (e.g. a bank) which provides the fund account and the financial institution (e.g. a securities company) which provides the accumulation account may be different financial institutions. In this case, transfer funds can be remitted or transferred to the financial institution which provides the accumulation account from the financial institution which provides the fund account. Here, in the embodiment described above, the fund transfer instruction means 15 transmits the predetermined fund transfer instruction information to the financial institution apparatus 30 on the basis of the fund calculation result information stored in the fund calculation result DB14 at the predetermined timing, and the predetermined timing is the timing at which a record targeted for processing is stored in the fund calculation result DB14, or a predetermined periodic timing such as every day or every month. In the case of the periodic timing in particular, more than one record are added together and then a total amount of money is remitted or transferred, which enables a low-cost operation when bank charges are collected. For example, some banks take no charge for a transfer between branches, so that a transfer can be conducted at the timing of the addition of a record if there are no bank charges, or processing can be performed at a periodic timing if there are bank charges.

Moreover, the display screens that can be displayed and accessed by the customer terminal shown in the embodiment described above are illustrative only, and it goes without saying that the configuration and contents of the screen can be set and changed in any manner.

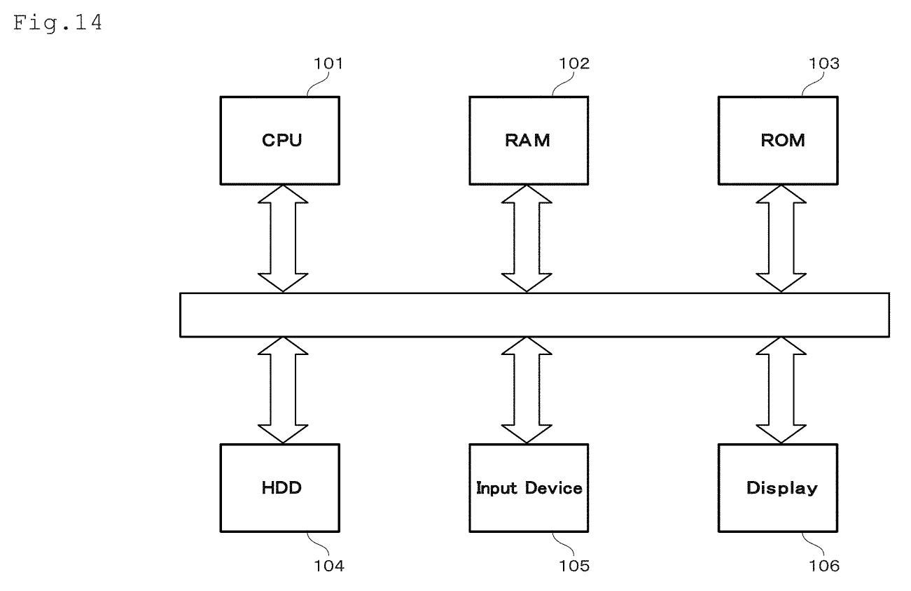

One example of the hardware configuration of the fractional fund transfer and accumulation server 10 and the customer terminal 40 described in the above embodiment is shown in FIG. 14, and this configuration comprises a CPU 101, a RAM 102, a ROM 103, an HDD 104, an input device 105, and a display device 106. These components are connected by a system bus, and exchange data via the system bus. The CPU (Central Processing Unit) 101 is also referred to as a central processing unit, and is a part which performs central processing of a computer, and controls each device and calculates/processes data. The RAM (Random Access Memory) 102 is a kind of a memory device, and is data erasable and writable. The ROM (Read Only Memory) 103 is a kind of a memory device using a semiconductor or the like, and allows data writing only once at the time of manufacture, and only allows reading of the recorded data when used. The HDD (Hard Disk Drive) 104 is a secondary storage which uses the properties of a magnetic substance to record and read information. The input device 105 is used for the user to operate and instruct a computer or to input characters and the like, and is specifically a keyboard, mouse, or the like. The display device 106 is, for example, a liquid crystal display, and may have a touch panel function. In addition, an unshown communication function is also provided, and this communication function enables a communication with other terminals. Moreover, the customer terminal 40 may be configured as a mobile terminal or the like, or may be what is called a smartphone or tablet.

In the operation described, a transfer procedure is conducted on the basis of transfer information generated along a set saving rule, and money is saved in the account for saving. However, it is possible to give an instruction to only cancel a money saving action selected by the user among saving actions of already accumulated money, in which case the amount of money corresponding to the target money saving action is transferred to an account for assets from the amount of money accumulated in the account for saving. This is described by use of the fund transfer result DB16 shown in FIG. 11. When records of already saved money stored in the fund transfer result DB16 are displayed on a user terminal as past money saving actions, the user selects a record to be cancelled, that is, a money saving action to be cancelled from the displayed records of already saved money, transmits, to the financial institution apparatus, a fund transfer instruction to transfer a transfer amount of money which is already transferred in the selected record to the account for assets from the account for saving, and updates the fund transfer status of the selected record to “cancel” after the transmission. Here, it is also possible to perform processing to delete the selected record instead of updating to “cancel”. When more than one record of already saved money are selected as cancellation targets, a fund transfer instruction can be generated for each of the selected records and then transmitted to the financial institution apparatus, but a total amount of money which is the total of transfer money of the selected records can be generated as one fund transfer instruction, and this fund transfer instruction can be then transmitted to the financial institution apparatus.

When money saving needs to be stopped or when the target amount of money has been reached, the user indicates this fact to the system, in which case the money which has been so far accumulated for saving can be transferred to the account designated by the user (which may be the account for assets, another account of the same financial institution, or an account of some other financial institution). When money saving needs to be stopped or when the target amount of money has been reached, it is also possible to perform an operation to delete the records stored in the fund transfer result DB16, but the records can also be kept stored as past saved money. For example, the records can be maintained as a default operation, and a target record can be deleted under an instruction from the user. Here, the past saved money is desirably displayed to the user in distinction from the money being saved at present, and the money being saved at present is only displayed at normal times, and only when the user requests the display of the past saved money, the past saved money may be displayed, and the contents of the records may be displayed.

When there are more than one money saving, one money saving may need to be integrated with the other one money saving. In this case, when an account is prepared for each money saving, it is possible to issue an instruction to transfer the money saved in the account for saving for one money saving to the account for saving for the other money saving from the account for saving for one money saving, and then transmit the instruction to the financial institution apparatus. In addition, the record recorded in the fund transfer result DB16 in connection with one money saving can be changed so that this record is connected to the record of the other money saving. In another case, an account may not be prepared for each money saving, and one account for saving may be used for more than one money saving. In this case, there is no need for the transfer to the account for saving, but there should be processing to connect the record recorded in the fund transfer result DB16 in connection with one money saving to the record of the other money saving.

Even if a predetermined saving action is to be taken, saving fails when there is no fund targeted for saving in the fund account. When there is no fund as above, the system can detect saving failures in the following examples.
A case where an amount of money in the account for assets held in the financial institution apparatus is recognized at the timing of the generation of a transfer instruction by the fractional fund transfer and accumulation server 10, and this amount of money is less than the transfer amount of money in the transfer instruction.
A case where an inquiry for the balance in the account for assets is made at the financial institution apparatus at the timing of the generation of a transfer instruction by the fractional fund transfer and accumulation server 10, and this amount of money is less than the transfer amount of money in the transfer instruction.
A case where the fractional fund transfer and accumulation server 10 generates a transfer instruction and transmits the transfer instruction to the financial institution apparatus, and the financial institution apparatus unsuccessfully conducts a transfer under the transfer instruction, and notifies the fractional fund transfer and accumulation server 10 of the unsuccessful transfer.

When the saving failure is detected as above, the following operations may be performed: an answer to the saving failure is reported to the person who saves money; the same transfer is again tried later on; and an answer to the transfer is reported to the person who saves money so that the current money saving operation is skipped and the next money saving operation is performed at the next timing.

In the arrangement described in [Common account setting] according to the above embodiment, one savings account is set by more than one user, and more than one user carry out one money saving. However, even when more than one user carry out one money saving, the following operation may be performed: each user saves money in his/her own account for saving, that is, each user sets a rule and performs the money saving operation accordingly, money is accumulated in each account, and the total amount of money saved for one money saving by the users is displayed as an amount of money saved.

### INDUSTRIAL APPLICABILITY

The present invention is suitably usable in a fractional fund transfer and accumulation system which supports financial institutions or the like in the business of offering investors advice and proposals regarding investments.

### DESCRIPTION OF REFERENCE NUMBERS

10: fractional fund transfer and accumulation server
11: fund calculation rules DB
12: account information DB
13: fund calculation means
14: fund calculation result DB
15: fund transfer instruction means
16: fund transfer result DB
17: accumulated fund reference means (accumulated fund information generating means)
20: financial institution apparatus (card company)
30: financial institution apparatus (bank)
31: fund account DB
32: accumulation account DB
40: customer terminal
41: fund calculation rules setting means
42: display means
101: CPU
102: RAM
103: ROM
104: HDD
105: input device
106: display device (display)

1. A fractional fund transfer and accumulation system which transfers a fund to a predetermined accumulation account from a fund account of a customer on the basis of rule information set in response to an input operation by the customer, and thereby accumulates a predetermined target amount of money, the fractional fund transfer and accumulation system comprising:
fund calculation rules storage means which stores predetermined fund calculation rules information set in response to an input operation;
account information storage means which stores account information regarding the fund account of the customer;
fund calculation means which calculates a transfer amount of money of a transfer fund to be transferred to the predetermined accumulation account from the fund account of the customer on the basis of the fund calculation rules information;
fund transfer instruction means which transmits predetermined fund transfer instruction information to a predetermined financial institution apparatus that manages the fund account of the customer on the basis of the calculated transfer amount of money; and
accumulated fund information generating means which generates predetermined accumulated fund information including the transfer amount of money,
wherein the following rules are settable as the fund calculation rules:
a fractional rule to calculate, as the transfer amount of money, a fractional amount of money indicated by a difference between an amount of money in predetermined usage details information or transaction information and a predetermined set amount of money,
a periodic rule to calculate, as the transfer amount of money, a predetermined fixed amount of money in every predetermined period set by a user, and
an additional rule to calculate, as the transfer amount of money, a predetermined amount of money set by the user when event information preset by the user is input.

2. The fractional fund transfer and accumulation system according to claim 1, wherein a fund transfer status indicating whether or not the transfer is successful is changed in accordance with a fund transfer result from the financial institution apparatus.

3. The fractional fund transfer and accumulation system according to claim 1, wherein the fund transfer instruction means transmits the predetermined fund transfer instruction information to the financial institution apparatus at a predetermined periodic timing.

4. The fractional fund transfer and accumulation system according to claim 1, wherein
the fund calculation means calculates that an amount of money charged to the fund account of the customer has reached a predetermined value, and
the accumulated fund information generating means transmits, to a customer terminal operable by the customer, information indicating that the amount of money charged has reached the predetermined value.

5. The fractional fund transfer and accumulation system according to claim 1, wherein
the fund calculation means calculates a possibility that the total transfer amount of money may not reach the target amount of money, and
the accumulated fund information generating means transmits, to the customer terminal operable by the customer, information indicating the possibility that the total transfer amount of money may not reach the target amount of money.

6. The fractional fund transfer and accumulation system according to claim 1, wherein
when the transfer amount of money in the accumulation account reaches a predetermined amount of money, the financial institution apparatus can perform purchase processing for a predetermined financial product by the transferred fund.

7. The fractional fund transfer and accumulation system according to claim 1, wherein
more than one accumulation account are settable as the accumulation account by a single customer.

8. The fractional fund transfer and accumulation system according to claim 7, wherein
at least one of the fractional rule, the periodic rule, and the additional rule is settable in the accumulation accounts set by the single customer.

9. The fractional fund transfer and accumulation system according to claim 1, wherein
a common accumulation account is settable as the accumulation account by more than one customer.

10. The fractional fund transfer and accumulation system according to claim 9, wherein at least one of the fractional rule, the periodic rule, and the additional rule is settable in the common accumulation account set by the customers.

11. A fractional fund transfer and accumulation program for a computer constituting a system which transfers a fund to a predetermined accumulation account from a fund account of a customer on the basis of rule information set in response to an input operation by the customer, and thereby accumulates a predetermined target amount of money, the fractional fund transfer and accumulation program causing the computer to function as:
fund calculation rules storage means which stores predetermined fund calculation rules information set in response to an input operation;
account information storage means which stores account information regarding the fund account of the customer;
fund calculation means which calculates a transfer amount of money of a transfer fund to be transferred to the predetermined accumulation account from the fund account of the customer on the basis of the fund calculation rules information;
fund transfer instruction means which transmits predetermined fund transfer instruction information to a predetermined financial institution apparatus that manages the fund account of the customer on the basis of the calculated transfer amount of money; and
accumulated fund information generating means which generates predetermined accumulated fund information including the transfer amount of money,
wherein the following rules are settable as the fund calculation rules:
a fractional rule to calculate, as the transfer amount of money, a fractional amount of money indicated by a difference between an amount of money in predetermined usage details information or transaction information and a predetermined set amount of money,
a periodic rule to calculate, as the transfer amount of money, a predetermined fixed amount of money in every predetermined period set by a user, and
an additional rule to calculate, as the transfer amount of money, a predetermined amount of money set by the user when event information preset by the user is input.

12. A fractional fund transfer and accumulation method using a computer constituting a system which transfers a fund to a predetermined accumulation account from a fund account of a customer on the basis of rule information set in response to an input operation by the customer, and thereby accumulates a predetermined target amount of money, the fractional fund transfer and accumulation method using the computer to perform:
a fund calculation rules storage procedure to store predetermined fund calculation rules information set in response to an input operation;
an account information storage procedure to store account information regarding the fund account of the customer;
a fund calculation procedure to calculate a transfer amount of money of a transfer fund to be transferred to the predetermined accumulation account from the fund account of the customer on the basis of the fund calculation rules information;
a fund transfer instruction procedure to transmit predetermined fund transfer instruction information to a predetermined financial institution apparatus that manages the fund account of the customer on the basis of the calculated transfer amount of money; and
an accumulated fund information generating procedure to generate predetermined accumulated fund information including the transfer amount of money,
wherein the following rules are settable as the fund calculation rules:
a fractional rule to calculate, as the transfer amount of money, a fractional amount of money indicated by a difference between an amount of money in predetermined usage details information or transaction information and a predetermined set amount of money,
a periodic rule to calculate, as the transfer amount of money, a predetermined fixed amount of money in every predetermined period set by a user, and
an additional rule to calculate, as the transfer amount of money, a predetermined amount of money set by the user when event information preset by the user is input.
